(19) United States
(12) Patent Application Publication
(10) Pub. No.: US 2019/0299547 A1
(43) Pub. Date: Oct. 3, 2019

(54) HYBRID MANDREL

(71) Applicant: ROHR, INC, Chula Vista, CA (US)

(72) Inventors: Chittibabu SRIDHARAKANNAN, Kallang/Whampoa (SG); Mohamedali LIMALIA, Kuala Lumpur (MY)

(73) Assignee: ROHR, INC., Chula Vista, CA (US)

(21) Appl. No.: 15/937,341

(22) Filed: Mar. 27, 2018

(51) Int. Cl. B29C 70/54; B29C 70/30; B64D 29/00

(52) U.S. Cl. CPC B29C 70/54; B29C 70/30; B29L 2031/7504; B29K 2883/00; B64D 29/00

(57) ABSTRACT

A composite panel is disclosed. The composite panel includes a first composite layer and a composite stringer extending along the first composite layer, the composite stringer having a first end portion, a second end portion and an intermediate portion extending between the first end portion and the second end portion. At least one of the first end portion and the second end portion are hollow and the intermediate portion includes an interior material.

### FIELD

The present disclosure relates generally to aircraft engine nacelles and, more particularly, to methods and techniques used to fabricate hybrid composite hollow-hat and stuffed-hat structures or stringers used to strengthen aircraft engine nacelles.

### BACKGROUND

Many components for aircraft nacelles are manufactured using composite materials. Composite materials tend to have a high strength-to-weight advantage compared to traditional metals. One particular application for the use of composite materials is to fabricate panels. One such panel may include a single skin with multiple laminar layers that are formed from composite materials such as graphite or an aromatic polyamide fiber of high tensile strength that are embedded in a resin matrix. One or more stiffening members or stringers, sometimes referred to as “hollow hats” or “stuffed hats” due to their cross-sectional shape, may extend from the inside (non-aerodynamic) surface of the skin to provide additional strength to the panel. In certain cases, a mandrel is used to form the shape of the stiffening member or stringer, and the composite skin is co-cured together with the stiffening member or stringer with the mandrel in place. Following the curing process, partial removal of the mandrel or complete removal of sections thereof provides space to locate various components used to open and close and to secure and lock the nacelle.

### SUMMARY

A composite panel for use in a gas turbine engine nacelle is disclosed. In various embodiments, the composite panel includes a first composite layer and a composite stringer extending along the first composite layer, the composite stringer having a first end portion, a second end portion and an intermediate portion extending between the first end portion and the second end portion. At least one of the first end portion and the second end portion are hollow and the intermediate portion includes an interior material. In various embodiments, the interior material comprises one or more of a rubber-like material and a foam-like material, having sufficient strength to support the composite stringer during the layup and curing processes.

In various embodiments, the composite stringer defines a length along the first composite layer and includes a second composite layer extending along the length. In various embodiments, the second composite layer includes a first overlap portion extending along the length and in contact with the first composite layer and a second overlap portion extending along the length and in contact with the first composite layer. In various embodiments, the first composite layer comprises a first plurality of composite sublayers. In various embodiments, the second composite layer comprises a second plurality of composite sublayers. In various embodiments, a hinge or latch housing is disposed within at least one of the first end portion and the second end portion.

A method for fabricating a panel for a nacelle is disclosed. In various embodiments, the method comprises placing a first composite layer on a surface of a mold tool; positioning a first mandrel portion on the first composite layer; positioning a second mandrel portion on the first composite layer, the first mandrel portion and the second mandrel portion being positioned to define a length extending along the first composite layer; placing a second composite layer over the first mandrel portion and the second mandrel portion, the second composite layer defining a stringer along the length and the first composite layer and the second composite layer defining a composite layup; curing the composite layup; and removing the first mandrel portion to form a first hollow portion on a first end of the stringer and a stuffed portion intermediate the first end and a second end of the stringer, the stuffed portion having an interior material. In various embodiments, the interior material comprises one or more of a rubber-like material and a foam-like material.

In various embodiments, the second composite layer includes a first overlap portion extending along the length and in contact with the first composite layer and a second overlap portion extending along the length and in contact with the first composite layer. In various embodiments, the first composite layer comprises a first plurality of composite sublayers. In various embodiments, the second composite layer comprises a second plurality of composite sublayers. In various embodiments, the first mandrel portion comprises a silicone-rubber material. In various embodiments, the second mandrel portion comprises the foam-like material. In various embodiments, the method further includes positioning a third mandrel portion on the first composite layer opposite the first mandrel portion and removing the third mandrel portion to form a second hollow portion on the second end of the stringer.

A composite panel is disclosed. In various embodiments, the composite panel includes a first composite layer and a composite stringer extending along the first composite layer, the composite stringer having a first end portion, a second end portion and an intermediate portion extending between the first end portion and the second end portion, where at least one of the first end portion and the second end portion are hollow and the intermediate portion includes an interior material.

In various embodiments, the first end portion and the second end portion are hollow. In various embodiments, the interior material comprises one or more of a rubber-like material and a foam-like material. In various embodiments, the composite panel includes a hinge or latch housing disposed within at least one of the first end portion and the second end portion. In various embodiments, the composite panel includes a hinge disposed within the first end portion and a latch housing disposed within the second end portion.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1A is a schematic cutaway view of a gas turbine engine and nacelle, in accordance with various embodiments;

FIG. 1B is a perspective view of a composite nacelle having hollow-hat stiffeners and components mounted therein, in accordance with various embodiments;

FIGS. 2A and 2B are schematic views illustrating end portions of stiffeners and steps used to fabricate stiffeners, in accordance with various embodiments; and

FIGS. 3A, 3B and 3C are schematic views illustrating steps used to fabricate stiffeners, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

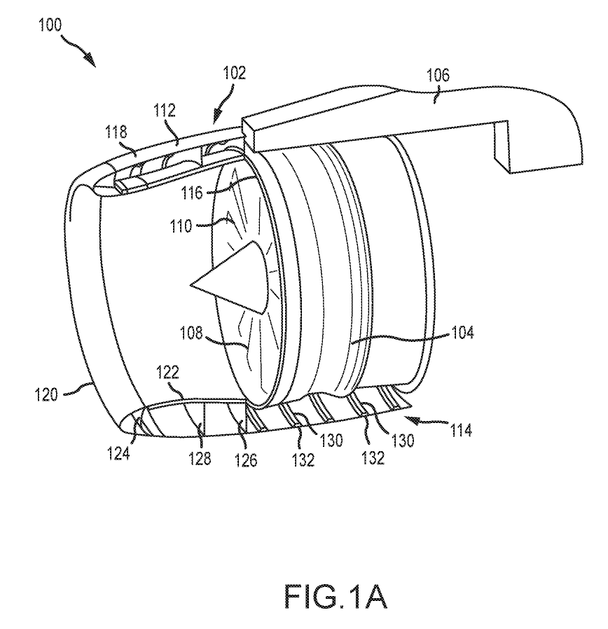

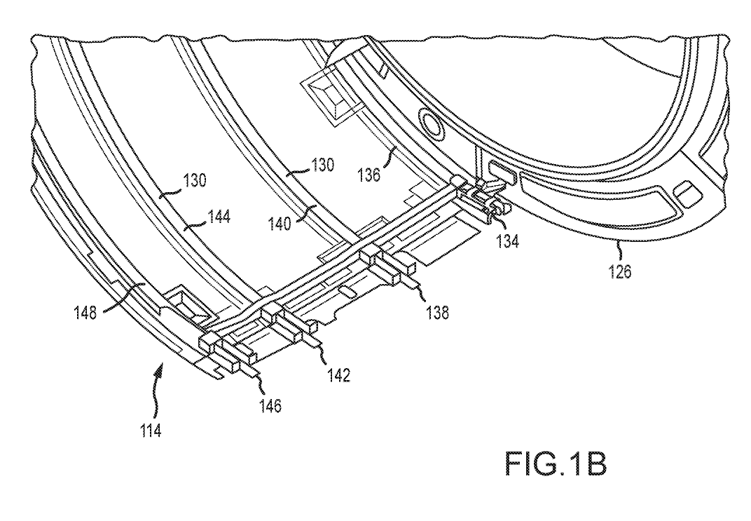

Referring now to the drawings, FIGS. 1A and 1B illustrate schematic cutaway views of a turbofan engine 100, in accordance with various embodiments. As shown in FIGS. 1A and 1B, the turbofan engine 100 typically includes a nacelle structure 102 and a fan case 104. The turbofan engine 100, including the nacelle structure 102 and the fan case 104, can be suspended from an aircraft wing by a pylon 106. In the drawings, one side of the nacelle structure 102 is removed for ease of illustration. In various embodiments, the fan case 104 surrounds a fan 108 used to drive air aft of the turbofan engine 100 to propel the aircraft. The fan 108 includes a plurality of fan blades 110 attached to an engine rotor.

As shown in FIG. 1A, the nacelle structure 102 includes a forward inlet portion 112 and an aft nacelle portion 114. The forward inlet portion 112 is typically attached to a forward flange 116 on the fan case 104 by a plurality of circumferentially spaced fasteners, such as bolts or the like. The forward inlet portion 112 typically includes an outer barrel 118, a nose lip 120, an inner barrel 122 and one or more spaced bulkheads, such as a forward bulkhead 124, an aft bulkhead 126 and an intermediate bulkhead 128. The bulkheads contribute to the rigidity and strength of the forward inlet portion 112. In addition, the intermediate bulkhead 128 and aft bulkhead 126 transmit loads between the inner barrel 122 and the outer barrel 118.

Referring still to FIGS. 1A and 1B, a plurality of stringers 130 extend circumferentially about the aft nacelle portion 114. The plurality of stringers 130 provide torsional rigidity and bending stiffness, among other strength increasing characteristics, to the aft nacelle portion 114 sufficient to withstand the aerodynamic forces experienced by the nacelle structure 102 during flight and operation of the turbofan engine 100. The plurality of stringers 130 also provide sufficient rigidity and stiffness to allow the aft nacelle portion 114 to be opened, typically about hinges positioned adjacent the pylon 106, without damage so mechanics may access interior components of the turbofan engine 100 for maintenance. In various embodiments, components, such as, for example, hinges, latches or latch housings, are positioned within openings 132 in one or more of the plurality of stringers 130. For example, referring to FIG. 1B, a first latch housing 134 may be the positioned within an opening of a first stringer 136 and a second latch housing 138 may be positioned within an opening of a second stringer 140. Similarly, a third latch housing 142 may be positioned within an opening of a third stringer 144 and a fourth latch housing 146 may be positioned within an opening of a fourth stringer 148. The first, second, third and fourth latch housings include components, such as, for example, latches, that may be opened and closed to enable opening and closing of the aft nacelle portion 114 of the turbofan engine 100. In various embodiments, the aft nacelle portion 114 may be considered a fan cowl or a fan cowl panel and the description above and below regarding the aft nacelle portion 114 applies equally to either the fan cowl or the fan cowl panel. In accordance with various embodiments, the openings within the plurality of stringers 130 may be formed as described below.

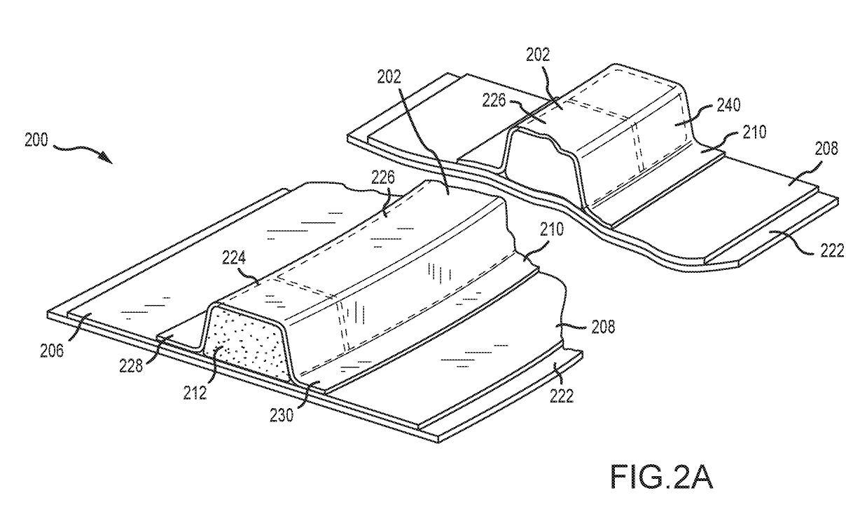

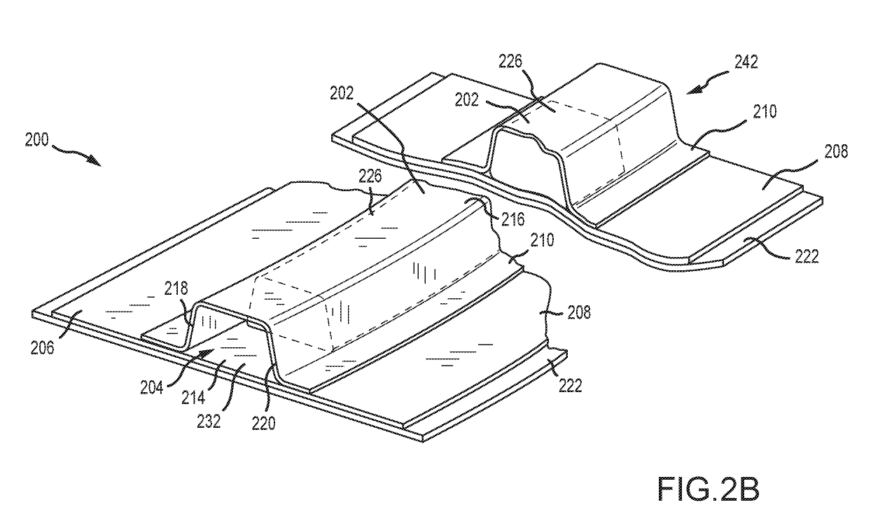

Referring now to FIGS. 2A and 2B schematic views illustrating the construction and other characteristics of a panel 200 including a stringer 202, such as one of the stringers 130 described above with reference to FIGS. 1A and 1B, and steps used to fabricate the panel 200 and a first opening 204 (or hollow portion) in the stringer 202, are provided, in accordance with various embodiments. For example, in various embodiments, the panel 200 includes a skin 206, that may itself comprise one or more layers of composite material formed from a fabric bonded together by a resin matrix. In various embodiments, the skin 206 includes a first layer 208 and a second layer 210. The stringer 202 may be formed and shaped by placing a stringer mandrel 212 between the first layer 208 and the second layer 210. The stringer 202 will then take the shape of the stringer mandrel 212 and may include, in various embodiments, a generally flat bottom 214, a generally flat top 216, a first angled side 218 and a second angled side 220. The first layer 208 may be shaped—e.g., in the form of a generally flat but gradually curved nacelle or fan cowl—by placing it on a mold tool 222 having the desired shape of the panel 200.

In various embodiments, the stringer mandrel 212 comprises a first mandrel portion 224 and a second mandrel portion 226. In various embodiments, the first mandrel portion 224 comprises a rubber-like material, such as, for example, natural rubber, synthetic rubber or silicone. In various embodiments, the second mandrel portion 226 comprises a foam-like material, such as, for example, a cell-structured foam, such as that sold under the tradename Rohacell® available from Evonik Resource Efficiency, GmbH, located in Essen, Germany, any polymeric foam, any polymethacrylimide based foam or any foam produced by thermal expansion of a co-polymer sheet of methacrylic acid and methacrylonitrile. These and similar foams possess sufficient strength to support the stringer 202 during the layup and curing processes. In various embodiments, the second mandrel portion 226 may comprise the rubber-like silicon material used for the first mandrel portion 224. As described with additional detail below, in various embodiments, the panel 200 may be fabricated by first laying the first layer 208 of composite material on the mold tool 222. As illustrated in FIG. 2A, the first mandrel portion 224 and the second mandrel portion 226 are then positioned on the first layer 208 and subsequently covered by the second layer 210. In various embodiments, the second layer 210 has a first overlap portion 228 and a second overlap portion 230 that overlap adjacent portions of the first layer 208. The resulting composite layup may then be cured using, for example, a curing oven, an autoclave or a furnace.

Once cured, the first layer 208 and the second layer 210 are structurally bonded together into a unitary structure in the form of the panel 200. In various embodiments, the first mandrel portion 224 is then removed, resulting in the first opening 204 or hollow portion positioned at a first end 232 of the stringer 202 and the panel 200. In various embodiments, the silicon rubber used to form the first mandrel portion 224 expands slightly during the curing process due to thermal expansion. Once the curing process is complete and upon cooling, the first mandrel portion 224 returns to its unexpanded shape, allowing for its removal from the stringer 202. In various embodiments, the second mandrel portion 226 remains within the stringer 202, providing an interior material to form a stuffed-hat portion of the stringer 202. In various embodiments, a third mandrel portion 240, similar to the first mandrel portion 224, is positioned at a second end of the stringer 202, providing hollow-hat openings at both ends of the stringer 202, including the first opening 204 and a second opening 242, following the curing process and removal of the first mandrel portion 224 and the third mandrel portion 240 from the respective first and second ends of the stringer 202.

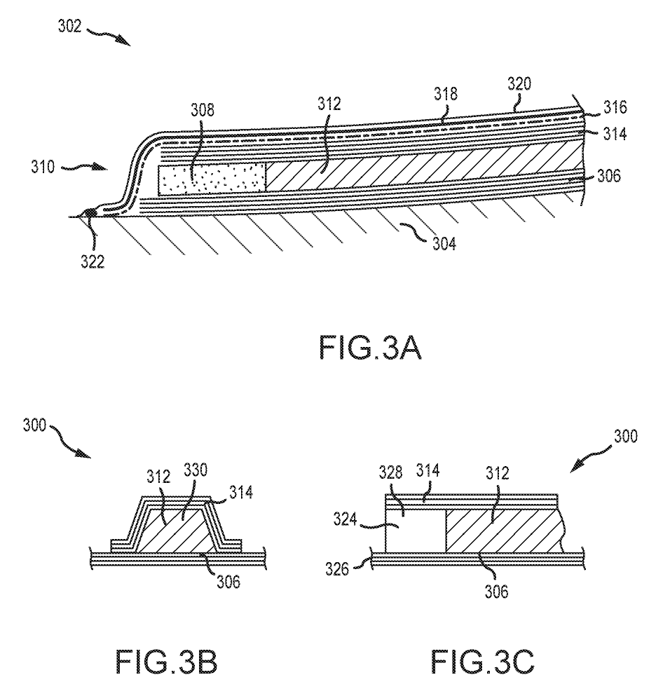

Referring now to FIGS. 3A, 3B and 3C, schematic views illustrating steps used to fabricate a stringer 300, in accordance with various embodiments, are provided. Referring to FIG. 3A, a composite layup 302 used during fabrication of the stringer 300 of a composite panel is illustrated, according to various embodiments. The composite layup 302 is constructed on a surface of a mold tool 304. A first plurality of layers 306 is placed on the surface of the mold tool 304. In various embodiments, the first plurality of layers 306 is similar to the first layer 208 described above with reference to FIGS. 2A and 2B. For example, the first layer 208 may, in various embodiments, comprise a plurality of sublayers, such as the first plurality of layers 306. In various embodiments, each layer (or sublayer) comprising the first plurality of layers 306 is a composite pre-impregnated sheet, or “prepreg,” which may comprise a composite material formed from a fabric bonded together by a resin matrix. A first mandrel portion 308 is positioned atop the first plurality of layers 306 at a first end 310 of the composite layup 302. A second mandrel portion 312 is likewise positioned atop the first plurality of layers 306 and extends toward a second end of the composite layup 302. In various embodiments, the first mandrel portion 308 and the second mandrel portion 312 are similar to the first mandrel portion 224 and the second mandrel portion 226 described above with reference to FIGS. 2A and 2B. In various embodiments, the first mandrel portion 308 comprises a rubber-like material, such as, for example, a silicone rubber. In various embodiments, the second mandrel portion 312 comprises a foam-like material, such as, for example, a cell-structured foam.

A second plurality of layers 314 is then positioned atop the first mandrel portion 308 and the second mandrel portion 312 and includes a first overlap portion and a second overlap portion that overlap adjacent portions of the first plurality of layers 306. In various embodiments, the second plurality of layers 314 is similar to the second layer 210 described above with reference to FIGS. 2A and 2B. For example, the second layer 210 may, in various embodiments, comprise a plurality of sublayers, such as the second plurality of layers 314. In various embodiments, each layer (or sublayer) comprising the second plurality of layers 314 is a composite pre-impregnated sheet, or “prepreg,” which may comprise a composite material formed from a fabric bonded together by a resin matrix. In various embodiments, the composite layup 302 further comprises a release film 316 positioned over the first plurality of layers 306 (where not covered by the second plurality of layers 314) and the second plurality of layers 314 and an air weave 318 positioned over the release film 316. A nylon vacuum bag 320 is then placed over the air weave 318. In various embodiments, the nylon vacuum bag 320 is sealed to a portion of the mold tool 304 using a sealant tape 322. Following construction as outlined above, the composite layup 302 is cured in a curing oven or furnace, followed by removal of the release film 316, the air weave 318, the nylon vacuum bag 320 and any sealant tape 322 used for vacuum bagging.

Once the composite layup 302 is cured, the first plurality of layers 306 and the second plurality of layers 314 are structurally bonded together into a unitary structure in the form of a panel, similar to the panel 200 described above with reference to FIGS. 2A and 2B. In various embodiments, the first mandrel portion 308 is then removed, resulting in a hollow portion 324 positioned at a first end 326 of the stringer 300. In various embodiments, the silicon rubber used to form the first mandrel portion 308 expands slightly during the curing process due to thermal expansion. Once the curing process is complete and cooling has occurred, the first mandrel portion 308 returns to its unexpanded shape, allowing for removal from the stringer 300. In various embodiments, the second mandrel portion 312 remains within the stringer 300. In various embodiments, a third mandrel portion, similar to the first mandrel portion, is positioned at a second end of the stringer 300, providing hollow-hat openings at both ends of the stringer 300 following the curing process and removal of the first mandrel portion and the third mandrel portion from the respective first and second ends of the stringer 300.

Referring now to FIGS. 3B and 3C, cross sectional views of the stringer 300 made from the composite layup 302 illustrated in FIG. 3A are illustrated. Following curing and removal of the non-composite portions, the stringer 300 includes a hollow-hat portion 328 in the vicinity of the hollow portion 324, where the first mandrel portion 308 is removed, and a stuffed-hat portion 330, where the second mandrel portion 312 remains. The hollow-hat portion 328 in the stringer 300 provides a space where components of a nacelle or fan cowl may be positioned. In various embodiments, such components may include one or more of the first, second, third and fourth latch housings, or the hinges or the latches described above with reference to FIG. 1B or other like components.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A composite panel for a nacelle, comprising:
a first composite layer; and
a composite stringer extending along the first composite layer and having a first end portion, a second end portion and an intermediate portion extending between the first end portion and the second end portion,
wherein at least one of the first end portion and the second end portion are hollow and the intermediate portion includes an interior material.

2. The composite panel of claim 1, wherein the interior material comprises one or more of a rubber-like material and a foam-like material.

3. The composite panel of claim 1, wherein the composite stringer defines a length along the first composite layer and comprises a second composite layer extending along the length.

4. The composite panel of claim 3, wherein the second composite layer includes a first overlap portion extending along the length and in contact with the first composite layer and a second overlap portion extending along the length and in contact with the first composite layer.

5. The composite panel of claim 3, wherein the first composite layer comprises a first plurality of composite sublayers.

6. The composite panel of claim 5, wherein the second composite layer comprises a second plurality of composite sublayers.

7. The composite panel of claim 6, further comprising a hinge or latch housing disposed within at least one of the first end portion and the second end portion.

8. A method for fabricating a panel for a nacelle, comprising:
placing a first composite layer on a surface of a mold tool;
positioning a first mandrel portion on the first composite layer;
positioning a second mandrel portion on the first composite layer, wherein the first mandrel portion and the second mandrel portion are positioned to define a length extending along the first composite layer;
placing a second composite layer over the first mandrel portion and the second mandrel portion, wherein the second composite layer defines a stringer along the length and wherein the first composite layer and the second composite layer define a composite layup;
curing the composite layup; and
removing the first mandrel portion to form a first hollow portion on a first end of the stringer and a stuffed portion intermediate the first end and a second end of the stringer, the stuffed portion having an interior material.

9. The method of claim 8, wherein the interior material comprises one or more of a rubber-like material and a foam-like material.

10. The method of claim 9, wherein the second composite layer includes a first overlap portion extending along the length and in contact with the first composite layer and a second overlap portion extending along the length and in contact with the first composite layer.

11. The method of claim 9, wherein the first composite layer comprises a first plurality of composite sublayers.

12. The method of claim 11, wherein the second composite layer comprises a second plurality of composite sublayers.

13. The method of claim 9, wherein the first mandrel portion comprises a silicone-rubber material.

14. The method of claim 13, wherein the second mandrel portion comprises the foam-like material.

15. The method of claim 8, further comprising:
positioning a third mandrel portion on the first composite layer opposite the first mandrel portion along the length;
removing the third mandrel portion to form a second hollow portion on the second end of the stringer.

16. A composite panel, comprising:
a first composite layer; and
a composite stringer extending along the first composite layer and having a first end portion, a second end portion and an intermediate portion extending between the first end portion and the second end portion,
wherein at least one of the first end portion and the second end portion are hollow and the intermediate portion includes an interior material.

17. The composite panel of claim 16, wherein the first end portion and the second end portion are hollow.

18. The composite panel of claim 16, wherein the interior material comprises one or more of a rubber-like material and a foam-like material.

19. The composite panel of claim 17, further comprising a hinge or latch housing disposed within at least one of the first end portion and the second end portion.

20. The composite panel of claim 17, further comprising a hinge disposed within the first end portion and a latch housing disposed within the second end portion.
